(19) United States
(12) Patent Application Publication
(10) Pub. No.: US 2006/0162582 A1
(43) Pub. Date: Jul. 27, 2006

(54) Multi-station press machine

(76) Inventor: John Turner, Nottinghamshire (DE)

Correspondence Address: ALTMAN & MARTIN, 6 BEACON ST, STE 600, BOSTON, MA, 02108, US

(21) Appl. No.: 10/520,025

(22) PCT Filed: Jul. 4, 2003
(86) PCT No.: PCT/GB03/02894

§ 371 Date: Jan. 30, 2006

(30) Foreign Application Priority Data
Jul. 5, 2002 (GB) 0215528.1

(51) Int. Cl. B44B 5/00

(52) U.S. Cl. 101/31.1

(57) ABSTRACT

A print-finishing press comprises a bed (5) for receiving a workpiece, a hydraulic ram mounted to effect relative movement between the bed and a press tool (9), and pressure control means for selectively pre-setting the hydraulic pressure applied to the ram to any of a number of predetermined levels.

### FIELD OF THE INVENTION

This invention relates to a multi-station press machine for performing a number of pressing tasks sequentially on items fed therethrough.

### BACKGROUND TO THE INVENTION

In the production of decorative cards such as greetings cards, multiple operations may be carried out on the printed card sheet to produce a finished greetings card, for example hot foiling, die cutting and embossing. Typically, multi-station press machines used in greetings card manufacture operate by levers linked to a common drive mechanism so as to synchronize the successive operations as the card blanks pass through the machine. This arrangement has two principal disadvantages. Firstly, the mechanical parts of the machine are complex, and therefore costly to manufacture. Secondly, the machine is difficult to adapt to short runs of different types of card, because the linkages for the mechanical press levers have to be individually adjusted to apply the correct pressure for the desired process, and adjustment is not straightforward. For both these reasons, the machines tend to be used for longer, higher volume runs of the same cards, with multiple passes through.

Alternatively, single station press machines may be employed, using a mechanically-driven platen. For multiple operations, after a batch of cards has undergone the first operation in the machine, the machine is then reconfigured for the second operation, typically involving replacement of the press tool on the platen with a different type of tool, and adjustment of the mechanical force applied to the platen during operation, to a value suited to the particular operation. The adjustment requires skill to ensure that the pressure applied is at an optimum for the operation; incorrect pressure could result in the batch being rejected. There is therefore a down time between successive operations, reducing productivity of the machine.

A further disadvantage with mechanical platen presses is that generally faster machines are more costly to manufacture than slower machines; to achieve high speed with high pressing force is typically costly.

### SUMMARY OF THE INVENTION

According to a first aspect of the present invention, there is provided a print-finishing press as defined by claim 1.

A second aspect provides a multi-station print-finishing press as defined by claim 3.

The invention also provides a print-finishing press comprising a moving bed for receiving a workpiece, a hydraulic ram mounted below the moving bed, and a press tool removably mounted on a fixed bed above the moving bed, pressure control means being provided for selectively pre-setting the hydraulic pressure applied to the ram to any of a number of predetermined levels.

The invention also provides a print-finishing press comprising a bed for receiving a workpiece, a hydraulic ram mounted above the bed and a press tool removably mounted on the ram for movement on to and away from the bed, pressure control means being provided for selectively pre-setting the hydraulic pressure applied to the ram to any of a number of predetermined levels.

The control means is preferably arranged to permit selection of pre-determined combinations of ram speed, pressure applied, and pressing time to suit different operations and materials, and is preferably programmable to apply the correct combination according to operator selections of material and press-tool types.

The invention also provides a multi-station print-finishing press, comprising a plurality of press stations, each press station comprising a hydraulic ram driving a press tool, conveying means for conveying a workpiece from one station to the next, and control means for controlling the operation of the press stations and the conveying means to perform a sequence of operations on each workpiece.

Preferably, the conveying means comprise, for each adjacent pair of press stations, gripping means for selectively gripping and releasing an edge of a workpiece, the gripping means being carried by a reciprocating carrier, whereby the workpiece is lifted from the first press station of the pair and deposited on to the next adjacent press station. The reciprocating carrier then returns the gripping means to the first of any pair of the press stations to move the next workpiece, while another such arrangement moves the workpiece on to the next stage or simply to the end stack of finished blanks, ready for any subsequent operations or processes, for example trimming and folding as required.

In the multi-station press, each press station is suitably a press according to the first aspect of the invention.

The control means is preferably linked to transducers detecting the instantaneous positions of the conveying means and the press tools so as to synchronise the operation of the different elements to maximise throughput of the workpieces.

### BRIEF DESCRIPTION OF THE DRAWINGS

In the drawings, which illustrate an exemplary embodiment of the invention:

FIG. 1 is a perspective view of the machine with three press stations, with the in-feed and outfeed handling removed;

FIG. 2 is an end elevation of the machine shown in FIG. 1;

FIG. 3 is a side elevation of the machine shown in FIGS. 1 and 2, with end tables added;

FIG. 4 is a simplified top plan view of the machine with the upper part of the machine removed and showing the passage of workpiece through it; and

FIG. 5 is an enlarged plan view of a workpiece being transported by the conveyor device.

### DETAILED DESCRIPTION OF THE ILLUSTRATED EMBODIMENTS

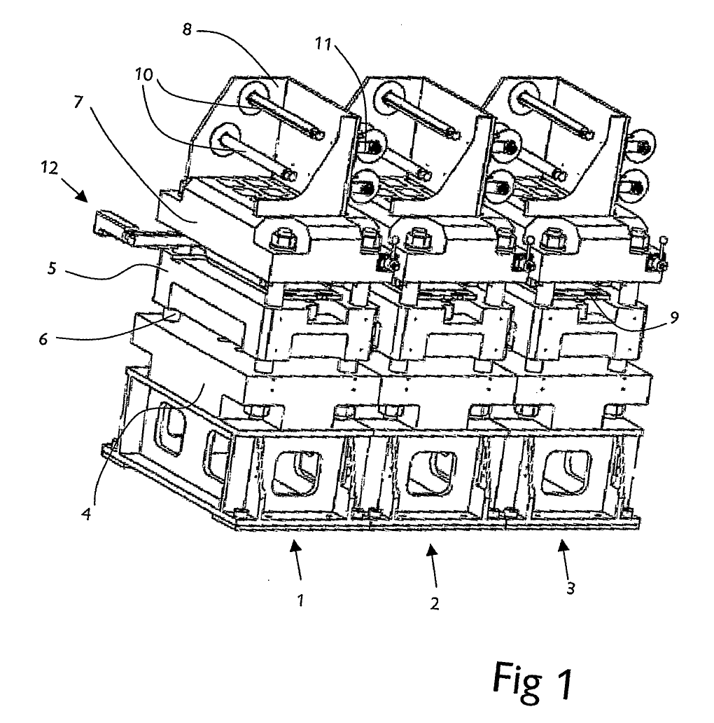

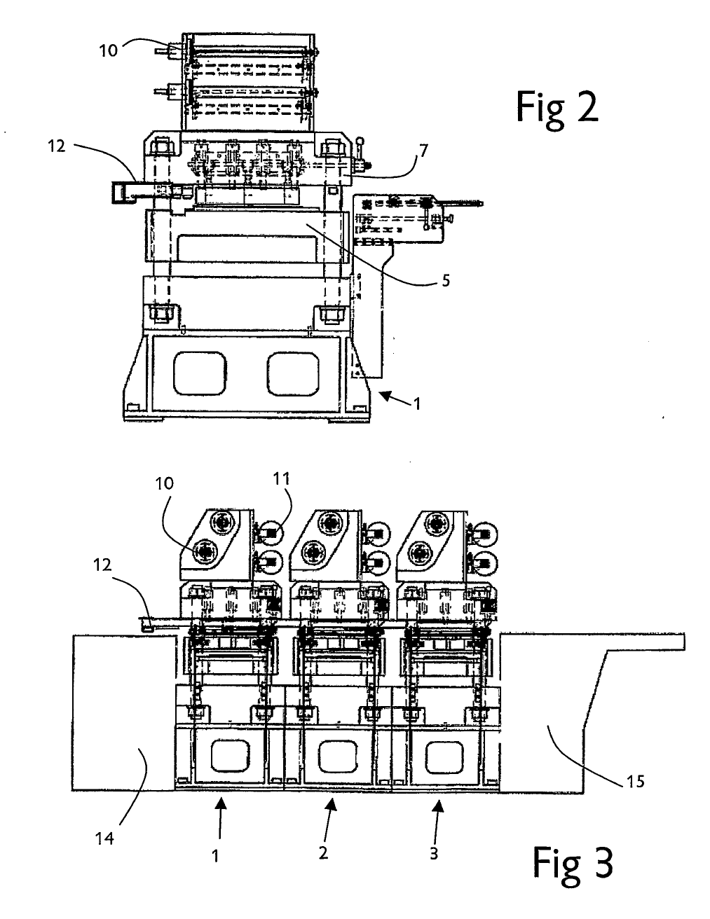

Referring first to FIGS. 1 to 3, a three-station print finishing press comprises three substantially identical modular units 1, 2 and 3, each consisting of a base frame 4 containing a hydraulic ram (not shown) mounted vertically so as to act on a press bed plate 5 which is slidably mounted on four vertical pillars 6 extending upwardly from the base frame 4. The pillars 6 carry between them at their upper ends a fixed head plate 7 on which is mounted a carrier 8 to support reels of foil for use in a hot foiling process.

The underside of the fixed head plate 7 carries a support for the die or foiling tool 9 such that the tool can be slid into and out of position easily to permit a rapid changeover from one tool to another. In use, foil passes from a supply reel carried by a first horizontal support 11 down one side of the head plate 7, under the face of the die or tool 9 and back up the other side of the head plate 7, the waste material being wound on to a collection reel 10 mounted on the carrier 8.

It will be seen that the pressing action is carried out by extending the ram upwardly to carry with it the slidable press bed plate 5 carry on the workpiece and urging the plate 5 against the die 9 mounted beneath the head plate 7.

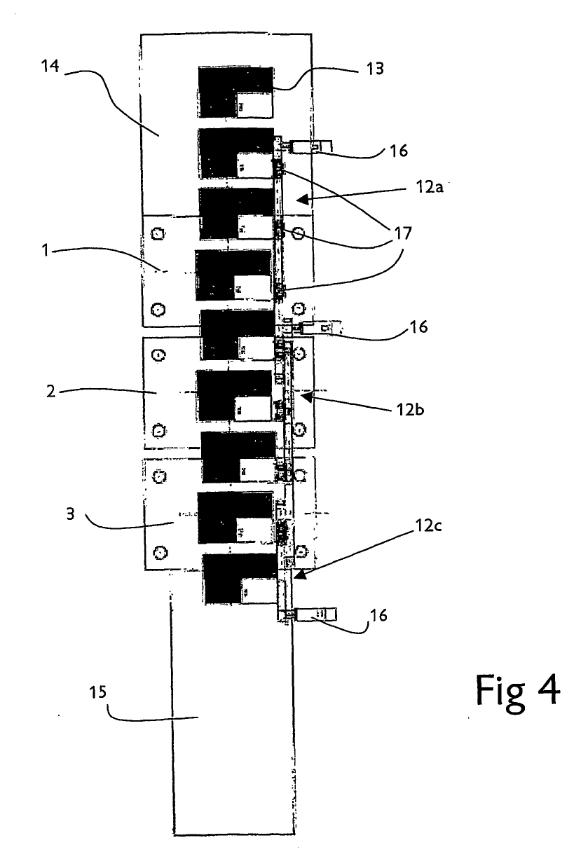

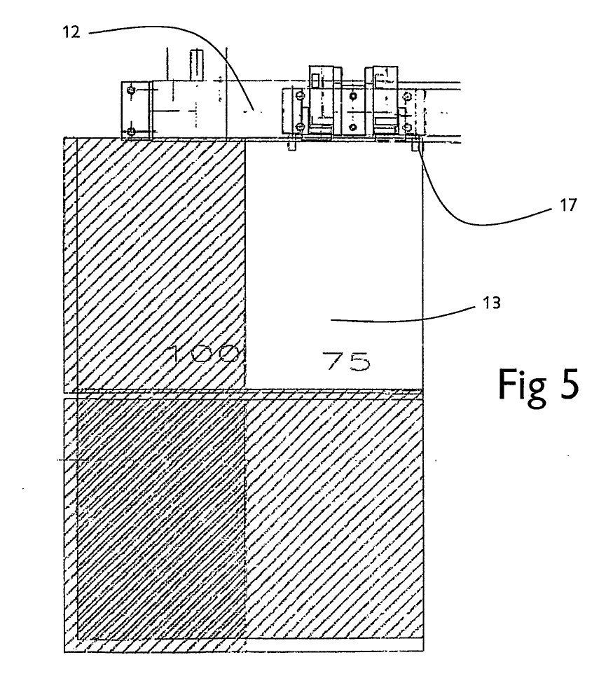

The modular nature of the machine means that it can be readily adapted to carry out different finishing processes, and in particular different combinations of processes, such as die stamping, embossing and foiling. Work pieces passed successively from one station to the next, being transported into, between, and out of the workstations by a conveyor 12 mounted between the slidable plates 5 and the head plates 7 inwardly of the pillars 6. The conveyor 12 is described hereinafter in greater detail with reference to FIGS. 4 and 5.

Referring to FIGS. 4 and 5, the conveyor 12 consists of three modular units 12a, 12b and 12c, mounted so as to overlap to provide continuous conveyance of the workpieces 13 from the input table 14 through the three workstations to the output table 15. Each of the units 12 consists of a track containing an endless belt mounted over support wheels within the track and driven by an electric motor 16 mounted at one end of the track. The motor will typically be a stepper motor to permit precise positional control. Pneumatically operated grippers 17, which can be seen more clearly from FIG. 5, are mounted at uniform intervals along the belt, units 12a and 12b having three grippers each, while the third unit 12c has only one gripper. The grippers are arranged to extend and retract transversely of the direction of motion of the belts and to be openable and closable to release and grip the workpieces.

It will be seen from FIG. 5 that the grippers are arranged to carry the card workpieces 13 by gripping only a small portion in the region of the card which is not to be finished by embossing, cutting or foiling. In conventional machines, an edge portion of the workpiece has to be left free of printing, embossing etc to permit it to be gripped by the conveying devices. This means that the edge portion has subsequently to be trimmed off, involving another operation, and so slowing production, and also generating waste. This advantage is achieved with single-fold cards or with double-folded cards. In FIG. 5, the printed/embossed/foiled areas are represented by hatching.

The modular construction of the machine, and the use of electrically driven belt positioners in the conveyors, enables the machine to be readily controlled by means of a computer control system, offering a high degree of flexibility in carrying out the finishing operations and moving the workpieces through the machine. In consequence, a high throughput can be achieved by the machines, and the machines can be readily adapted to process relatively short runs of print finishing of different types. The use of a hydraulic ram to control the pressing operation means that the pressure applied to the workpiece, and indeed the pattern of pressure applied, can be precisely controlled according to the materials being used. Thus, for example, an embossing action might require a different peak pressure, and different pressure profile, to a hot foiling operation. It will be understood that the foiling operation may require each, and this will be achieved by heating the foiling tool or die electrically.

1. A print-finishing press comprising a bed for receiving a workpiece, a hydraulic ram for effecting relative movement between the bed and a press tool towards and away from each other, and pressure control means for selectively pre-setting the hydraulic pressure applied to the ram to any of a number of predetermined levels.

2. A press according to claim 1, wherein the ram is mounted to urge the bed upwardly into engagement with the press tool fixedly mounted above it.

3. A multi-station print-finishing press, comprising a plurality of press stations, each press station comprising a hydraulic ram effecting relative movement between a press tool and a workpiece-receiving bed, conveying means for conveying a workpiece from one station to the next, and control means for controlling the operation of the press stations and the conveying means to perform a sequence of operations on each work-piece.

4. A multi-station press according to claim 3, wherein the conveying means comprise, for each adjacent pair of press stations, gripping means for selectively gripping and releasing an edge of a workpiece, the gripping means being carried by a reciprocating carrier, whereby the workpiece is lifted from the first press station of the pair and deposited on to the next adjacent press station.

5. (canceled)

6. A multi-station press according to claim 3, wherein the press station is a print-finishing press comprising a bed for receiving a workpiece, a hydraulic ram for effecting relative movement between the bed and a press tool towards and away from each other, and pressure control means for selectively pre-setting the hydraulic pressure applied to the ram to any of a number of predetermined levels.

7. A multi-station press according to claim 6, wherein the ram is mounted to urge the bed upwardly into engagement with the press tool fixedly mounted above it.

8. A multi-station press according to claim 4, wherein the press station is a print-finishing press comprising a bed for receiving a workpiece, a hydraulic ram for effecting relative movement between the bed and a press tool towards and away from each other, and pressure control means for selectively pre-setting the hydraulic pressure applied to the ram to any of a number of predetermined levels.

9. A multi-station press according to claim 8, wherein the ram is mounted to urge the bed upwardly into engagement with the press tool fixedly mounted above it.
